(19) United States
(12) Patent Application Publication
(10) Pub. No.: US 2009/0177755 A1
(43) Pub. Date: Jul. 9, 2009

(54) SCRIPT SERVING APPARATUS AND METHOD

(76) Inventor: Kevin B. Freeman, Manhattan Beach, CA (US)

Correspondence Address: Warren M Pate;WARREN M. PATE, LLC, P.O. Box 9758, Salt Lake City, UT, 84109, US

(21) Appl. No.: 12/265,178

(22) Filed: Nov. 5, 2008

Related U.S. Application Data
(60) Provisional application No. 60/987,618, filed on Nov. 13, 2007.

(51) Int. Cl. G06F 15/167; H04L 9/32

(52) U.S. Cl. 709/212; 726/4

(57) ABSTRACT

A computer system comprising a processor operably connected to a memory device. The memory device stores an application providing functionality and a plug-in augmenting that functionality. In selected embodiments, the plug-in includes a request module configured to generate a request for a script, a communication module configured to contact a server and submit the request thereto, an input module configured to receive the script from the server, and an execution module configured to load the script directly into application memory corresponding to the application.

### RELATED APPLICATION

This application claims the benefit of co-pending U.S. Provisional Patent Application Ser. No. 60/987,618 filed Nov. 13, 2007.

### BACKGROUND

1. Field of the Invention

This invention relates to script serving and, more particularly, to novel systems and methods for protecting and improving a script developer's source code and files.

2. Background

Open architectures allow third parties and independent developers to customize and extend applications. Programs written in scripting languages (e.g., scripts) provide a mechanism for end users to do this. However, the economic realities surrounding script development do not typically justify corresponding installation programs. Accordingly, if an end user would like to utilize a script, the user must typically locate the desired script, download the script code to a local machine, install the script on the local machine, and inform a corresponding application where the installed script is located. Thus, the inconvenience of installing scripts may limit their use.

Additionally, most scripting languages utilize user-readable text. Accordingly, the simple act of providing a script to an end user may provide the end user with full access to the source code. Accordingly, what is needed is a method for serving scripts that both increases the value of the scripts and protects that value.

### BRIEF SUMMARY OF THE INVENTION

In view of the foregoing, in accordance with the invention as embodied and broadly described herein, a method and apparatus are disclosed in one embodiment of the present invention for dynamically sourcing scripts, code, code segments, programs, applications, snippets, add on tools, utilities, extensions, and the like (collectively “scripts”) directly into running application memory. This may be done without requiring an end user to install and setup each script. This process may protect a script developer's source code and files.

In selected embodiments, an apparatus and method in accordance with the present invention may provide ease of installation, protection of source code, and facilitated script distribution. In certain embodiments, an end user may install a custom plug-in, applet, extension, or the like (hereinafter “plug-in”) in association with an application. When an end user desires the functionality of one or more scripts, he or she may so indicate, and the plug-in may generate and submit a script request. The one or more scripts requested may be passed to a script or distribution server on which the scripts may be stored.

A script server may validate the end user (e.g., determine whether the end user is authorized to receive a script). If the end user is valid, a script server may serve the desired script or scripts to the plug-in. The plug-in may load scripts straight into application memory of a running application. Accordingly, a script may be available for immediate use without having been installed. By this method, a script need not be saved on the computer of the end user and the end user may not access, read, or distribute the source code.

In certain embodiments, a user may be given an option to store an encrypted local copy of a requested script. If the user elects to store local copies, a plug-in may download a script straight into running application memory, encrypt a local copy of the script, and save the encrypted copy on a computer of the end user. In such embodiments, an end user may utilize a script when working offline. Moreover, the encryption may protect the source code, ensuring that the local copy is not human readable and cannot be distributed to other users.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram illustrating a computer system for running the system and method in accordance with the present invention;

FIG. 2 is a schematic block diagram illustrating the interaction between the computer of an end user, a plug-in server, and a script server in a system in accordance with the present invention;

FIG. 3 is a schematic block diagram illustrating one embodiment of a plug-in in accordance with the present invention;

FIG. 4 is a schematic block diagram illustrating one embodiment of a response manager in accordance with the present invention;

FIG. 5 is a schematic block diagram illustrating one embodiment of a user interface provided by a script manager in accordance with the present invention; and

FIG. 6 is a schematic block diagram illustrating one embodiment of a method in accordance with the present invention.

### DETAILED DESCRIPTION OF SELECTED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

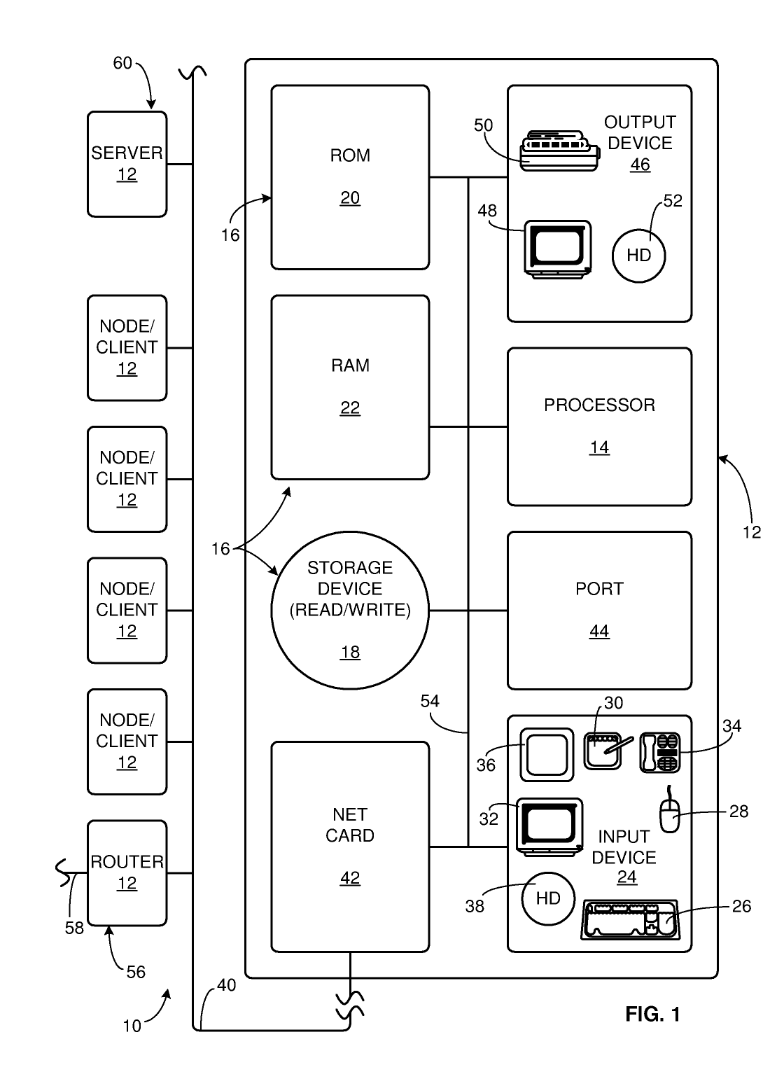

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

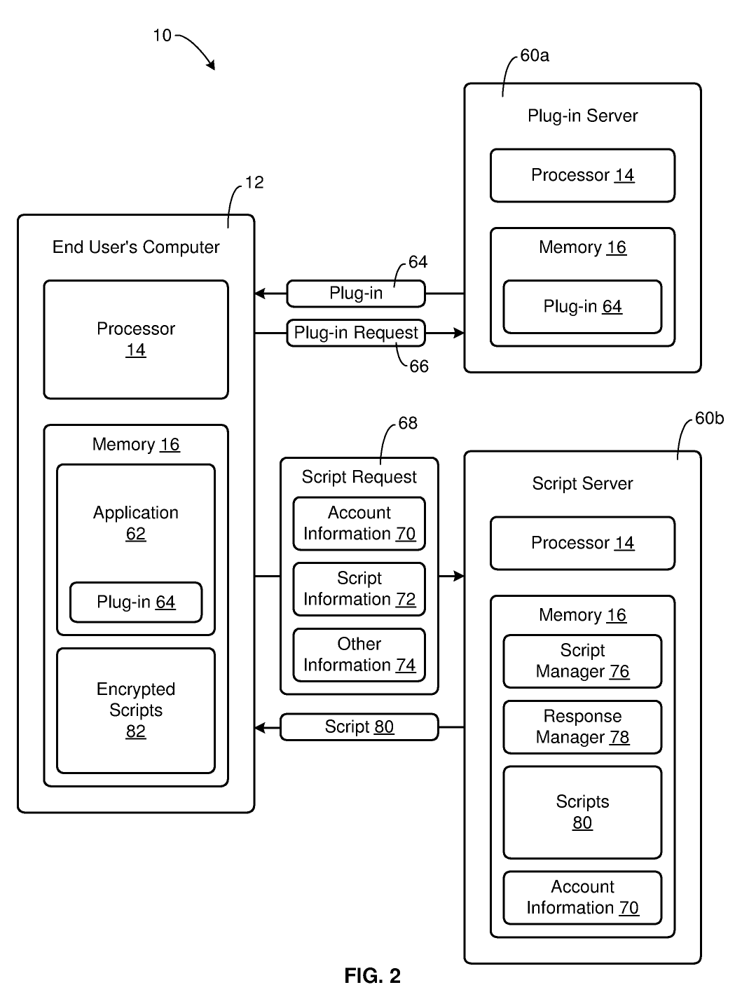

Referring to FIG. 2, certain functional units described herein may be referenced with descriptive names, referred to as modules, or some combination thereof. Such units may be implemented in hardware, software, or a combination thereof. For example, a functional unit (e.g., program, module, or the like) may comprise one or more physical or logical blocks of computer instructions. Such instructions need not be located physically together. They may be stored in different locations and, when logically joined, provide the desired functionality. Accordingly, a functional unit may comprise one or more instructions distributed across different code segments, programs, memory devices, etc. Data (e.g., operational data) may be similarly distributed.

In selected embodiments, an apparatus 10 in accordance with the present invention may comprise a computer 12 corresponding to an end user. Memory 16 associated with a computer 12 may store an application 62. An application 62 may be a computer program designed to aid an end user in performing certain tasks. Accordingly, an application 62 may provide certain functionality to an end user.

At times, an end user may desire to augment an application 62. For example, an end user may wish to alter a particular functionality or look-and-feel provided by an application 62. Alternatively, an end user may wish to incorporate entirely new functionality into the application 62. To augment an application 62, a developer may create a “plug-in” 64.

A plug-in 64 may be a program that augments (e.g., adds to, alters, etc.) the functionality, look-and-feel, or the like of an application 62. In selected embodiments, a plug-in 64 may augment an application 62 while leaving the foundation of the application 62 intact. A plug-in 64 may be developed as a single component or multiple components. In selected embodiments, an application 62 may include an Application Programming Interface (API) through which a plug-in 64 may interact with the application 62.

The computer 12 of an end user may receive a plug-in 64 in any suitable manner. For example, a developer may mail a CD-ROM storing the plug-in 64 to an end user, send an electronic correspondence forwarding a copy of the plug-in 64, or the like. In certain embodiments, a developer may provide a plug-in server 60a. A plug-in server 60a may store a plug-in 64 thereof. Via a computer network 40, 58 (e.g., the Internet), an end user may access the plug-in server 60a and download, to a computer 12, a copy of the plug-in 64.

Delivery of a plug-in 64 may be initiated by a plug-in request 66 communicated from an end user to a developer. In selected embodiments, a plug-in request 66 may be sent from the computer 12 of an end user to a plug-in server 60a. A plug-in request 66 in accordance with the present invention may simply comprise activation of a link to initiate downloading of the plug-in 64. Alternatively, a plug-in request 66 may be more complex and include generation of a user account, transmission of payment, execution of a license and the like. In response to a proper plug-in request 66, a developer may deliver a copy of the plug-in 64. For example, a plug-in server 60a may deliver a copy of the plug-in 64 to the computer 12 submitting the request 66. The end user may then install the plug-in 64 on the computer 12.

A plug-in 64 in accordance with the present invention may act as an interface between an application 62 corresponding to an end user and a script server 60b corresponding to a developer. In certain embodiments, a plug-in 64 may be registered with the corresponding application 62. Accordingly, an application 62 may recognize certain commands or instructions as pertaining to the plug-in 64, and hand them over to the plug-in 64 for processing.

After launching an application 62, an end user may activate a plug-in 64 associated therewith. For example, a plug-in may augment an application 62 by adding to a user interface thereof one or more menus, buttons, options, or the like. An end user may activate a plug-in 64 by selecting one such menu, button, option, etc. In response to this selection, a plug-in 64 may communicate with a script server 60b via a script request 68.

A script request 68 may take on any suitable form. In selected embodiments, a script request 68 may comprise one or more communications sent by a plug-in 64 to a script server 60b. These communications need not be sent as a single packet, but may be sequenced and intermingled with appropriate responses from a script server 60b.

In certain embodiments, upon receiving an appropriate command or instruction from an end user or an application 62, a plug-in 64 may coordinate generation and submission of a script request 68. Alternatively, such a command or instruction may itself comprise a script request 68, or at least a preliminary core thereof.

In selected embodiments, a script request 68 may contain account information 70. The account information 70 may identify an end user or a computer 12 corresponding to the end user. For example, account information 70 may include the username and password corresponding to an account generated as part of a plug-in request 66. Account information 70 may also include an Internet Protocol (IP) address corresponding to the end user's computer 12, data characterizing an application 62 (e.g., version data), other desired information, or some combination thereof.

A script request 68 may also include script information 72. Script information 72 may identify one or more scripts providing the functionality desired (e.g., selected) by the end user. In selected embodiments, a script request 68 may include other information 74 as desired or necessary. For example, a script request 68 may include data characterizing the plug-in 64 sending the request 68 and the like.

In selected embodiments, the software and hardware providing the plug-in server 60a and a script server 60b may be distributed across one or more physical locations or machines. Accordingly, a single node 12 may act as both a plug-in server 60a and a script server 60b. Alternatively, each of the plug-in server 60a and script server 60b may comprise one or more nodes 12.

In selected embodiments, a script server 60b may include a script manager 76, a response manager 78, one or more scripts 80, and the like. A script manager 76 may provide a mechanism through which a developer may access, organize, edit, release, etc. one or more scripts 80 corresponding thereto. A response manager 78 may receive script requests 68, determine whether the computers 12 or end users associated with the script requests 68 are valid, and deliver the scripts 80 to the appropriate computers 12.

In certain embodiments, a response manager 78 may consult account information 70 to determine whether a particular end user or computer 12 is authorized to receive one or more scripts 80. For example, a response manager 78 may compare the account information 70 received from a script request 68 with account information 70 collected or generated in handling a corresponding plug-in request 66.

In selected embodiments, a response manager 78 may access or utilize the account information collected or generated by a plug-in server 60a. This may be done in any suitable manner. For example, a response manager 78 may query a plug-in server 60a. Alternatively, a script server 60b may receive and maintain its own copy of the account information 70 collected or generated by a plug-in server 60a. Accordingly, regardless of whether the “server-side” account information 70 is stored on a plug-in server 60a, a script server 60b, somewhere else, or some combination thereof, a response manager 78 may use it to verify the authenticity of a script request 68.

In response to a valid script request 68, a script server 60b may serve a script 80 to a computer 12. A plug-in 64 may then load the script 80 straight into the application memory of a running application 62. Alternatively, an end user may be given an option to store an encrypted local copy of the script 80 or scripts 80 requested. This may permit an end user to utilize a script 80 even when working offline. If the user elects to store a local copy, a plug-in 64 may generate and save an encrypted script 82, then load the script 80 straight into the application memory of the running application 62.

The value of a script 80 may depend on various factors. In certain situations, the value of a script 80 may depend to some degree on how much a developer invests in the script 80. In general, the greater the investment by a developer, the more refined and useful (e.g., valuable) the resulting script 80. However, there may be motivations urging a developer not to make such investment.

For example, a developer may be less willing to invest in a script 80 if the developer has no way to control the script 80 after it is provided to an end user. Some developers may want compensation for use of their scripts 80. Other developers may be willing to provide certain scripts 80 at no cost, yet want credit for their work and creativity. The ease with which scripts 80 may be viewed, copied, shared, transported, altered, and the like may limit a developer's ability to control compensation, attribution, and the like. Accordingly, a developer's motivation to invest in scripts 80 so exposed may be lessened.

Another factor affecting the value of a script 80 may be whether an end user receives the benefit of the investment made by a developer. Even if a developer invests in a script 80, that investment may not reach an end user. Accordingly, the end user may value that script 80 as if the developer's investment were never made.

For example, an end user may find and install a script 80. Subsequent thereto, a developer may further invest in the script 80, making various improvements. However, an end user may not learn about the improvements. Moreover, if a developer is continually making improvements, an end user may tire of downloading and installing improved scripts 80. Accordingly, there may be a disconnect. As a result, an end user may not receive the benefit of the developer's investment.

A system 10 in accordance with the present invention may encourage developers to invest in scripts 80 by increasing the developers' control over their scripts 80. For example, by limiting access of end user to scripts 80 they are authorized to receive, a system 10 may control who can download a script. Moreover, by loading scripts 80 directly into running application memory and saving only encrypted copies 82 on the computer 12 of an end user, a system 10 may limit access to the script's 80 code. This may provide a control over viewing, copying, sharing, transporting, and altering the script 80. With the control provided by such a system 10, developer's may be motivated to create more and better scripts 80.

A system 10 in accordance with the present invention may remove the disconnect between an end user and the continual investment of a developer. For example, by first looking to obtain a script 80 from a script server 60b, a developer may ensure that an end user is receiving and using an appropriate (e.g., latest) version of the script 80. Accordingly, an end user need not learn about, find, or install anything to receive the benefit of the incremental or subsequent investments of a developer.

In selected embodiments, a system 10 may be dedicated to serving or distributing the scripts 80 of a particular developer. In other embodiments, a system 10 may serve the scripts 80 of multiple developers. In certain embodiments, a system 10 may be built, managed, or the like by a system owner. The system owner need not be an end user nor a developer. The system owner may simply provide a system 10 through which one or more developers may deliver or market their scripts 80 to end users.

In certain embodiments, a system owner may operate a system 10 in accordance with the present invention on a subscription basis. For example, a developer may pay a fee to serve or distribute its scripts 80 using the system 10. Similarly, developers may distribute scripts 80 on a subscription basis. Any payments received for use of a script 80 may be received directly by a corresponding developer. Alternatively, such payments may be routed from the end user, to the system owner, to the appropriate developer.

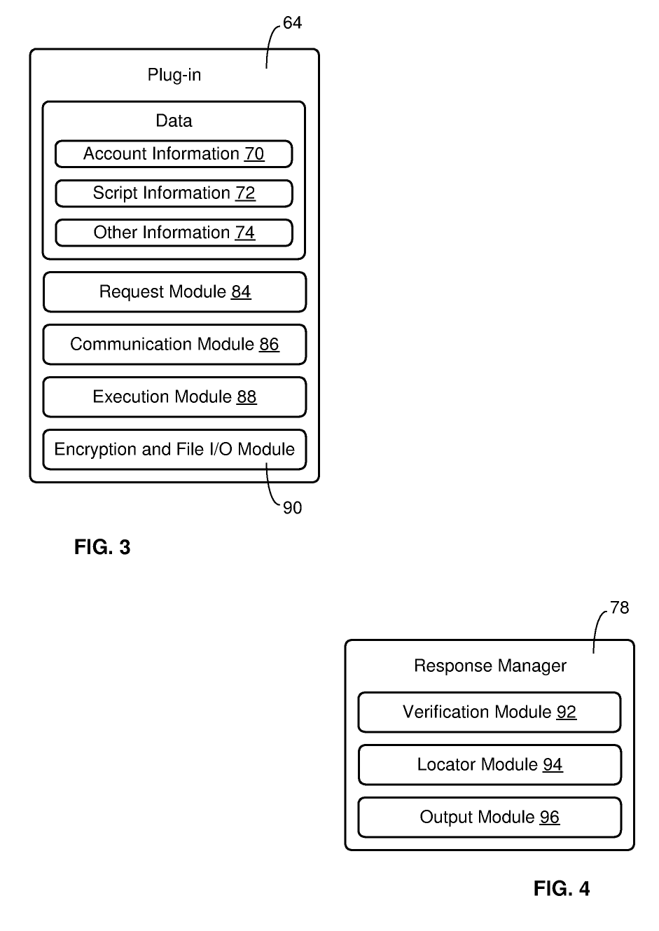

Referring to FIG. 3, a plug-in 64 may include various functional units to individually or collectively provide desired functionality. In selected embodiments, a plug-in 64 may include a request module 84. A request module 84 may initiate various actions and communications and direct the activities of the other modules of a plug-in 64. For example, a request module 84 may receive commands or instructions from a corresponding application 62, initiate requests 68 for server-side scripts 80, and assign tasks to the other modules to successfully execute a script 80.

A request module 84 may receive commands or instructions from an application 62 or end user in a variety of different ways. In selected embodiments, an end user may enter a command into a scripting interface of an application 62. The scripting interface may communicate directly with a scripting engine of the application 62. In other embodiments, commands or instructions may be run through open command ports in an application 62. These command ports may also communicate directly with a scripting engine of the application 62. Such embodiments may allow web browsers and the like to deliver commands or instructions by communicating with an application 62 through the open command ports.

In certain embodiments in accordance with the present invention, a request module 84 may validate the command or instruction (e.g., script request 68) received from the end user or the application 62. Next, a request module 84 may contact the appropriate script server 60b (e.g., the sever 60b specified by the request 68) to ensure that it is online and ready. A request module 84 may then direct a communication module 86 to validate the credentials of the end user or computer 12 of the end user. If the credentials are valid, a request module may direct a communication module 86 to request the script 80 from the server 60b.

A communication module 86 may be responsible for communication protocol. Accordingly, a communication module 86 may advise a request module 84 when a script 80 from the server 60b is ready for execution. The request module 84 may then direct an execution module 88 to source the script 80 into application memory and run any commands sent over as part of the script 80. Additionally, if an end user has requested offline access, a request module 84 may direct an encryption and file input and output module 90 to encrypt a local copy of the script 80 for use when no connection to the server 60b is available.

Referring to FIG. 4, in selected embodiments, a response manager 78 may reside on one or more servers 60 and have access to one or more scripts 80. Upon receipt of a script request 68 or some portion thereof, a response manager 78 may provide or coordinate an appropriate response. Such responses may be provided in any suitable form including any number of network scripting languages and technologies including ASP, PHP, and .NET.

In certain embodiments, a response module 78 may include one or more modules. For example, in one embodiment, a response module 78 may include a verification module 92, locator module 94, and an output module 96.

In operation, upon receipt of an initial communication or status check from a plug-in 64, a response manager 78 may respond by indicating its “ready” status. In response to a request to validate an end user or a computer 12 of the end user, a verification module 92 may compare the credentials provided by a plug-in 64 with stored information. Accordingly, a verification module 92 may determine whether an end user is a valid user and whether the end user has permission to receive selected scripts 80. If an end user is authorized to receive the selected scripts 80, a verification module 92 may so inform a plug-in 64.

After proper validation, a locator module 94 may respond to requests for one or more scripts 80 by locating those scripts 80. In selected embodiments, a locating module 94 may locate scripts 80 stored within a database. In other embodiments, a locating module may simply identify one or more stored files. Once located, an output module 96 may deliver the one or more scripts 80 to a plug-in 64.

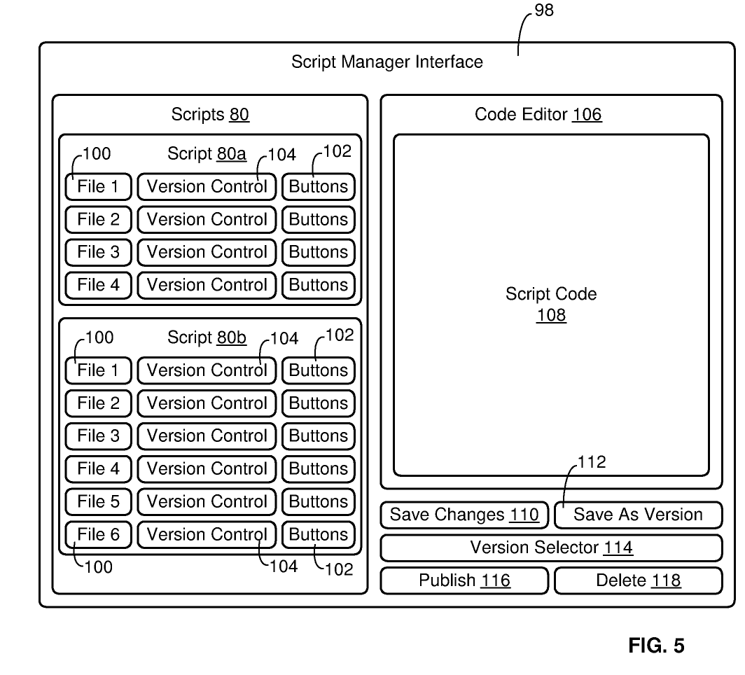

Referring to FIG. 5, a script manager 78 in accordance with the present invention may provide a mechanism through which one or more developers may manage their respective scripts 80. In selected embodiments, a script manager 78 may provide a user interface 98. Through the user interface 98, a developer may upload and download scripts 80, edit scripts 80, create and manage the various versions of a script 80, control the one or more files 100 that makeup a script 80, and the like.

A user interface 98 may have any suitable form. In selected embodiments, a user interface 98 may list scripts 80 and the files 100 associated with each script 80. An interface 98 may provide various information, buttons 102, displays, and the like for each script 80 or file 100. For example, a user interface 98 may display or provide for each script 80 or file 100 a name, a category, file sharing controls and status indicators, file including controls and status indicators, version controls 104, a delete button, a rename button, and the like.

Using the version controls 104, a developer may retrieve the various versions of a script 80 or file 100. In selected embodiments, a published script 80 or file 100 may indicate the version from which it was published. Accordingly, to modify a published version of a script 80 or file 100, a developer may access that version, make the desired modifications, save the changes (e.g., as a new version), and publish the modified script 80 or file 100. If desired, scripts 80 may be sourced directly from a user interface 98.

Code for the various scripts 80 and files 100 may be edited in any suitable manner. In certain embodiments, a user interface 98 may include a space 106 for displaying the code 108 of a script 80 or file 100. This space 106 may comprise a code editor 106. Accordingly, code 108 displayed in the space 106 may be edited or modified. For example, by selecting a particular file 100 and using the version controls 104 to identify a particular version, the particular version of the particular file 100 may be displayed within the code editor 106. In selected embodiments, a user interface 98 may support syntax highlighting within a code editor 106. In one embodiment, this feature may be turned on or off. Syntax highlighting may facilitate interpretation, searching, and the like of script code 108 displayed in a code editor 106.

A user interface 98 may include various buttons for performing selected functions with respect to a script 80 or file 100 displayed within a code editor 106. For example, a user interface 98 may include a “save changes” button 110. Such a button 110 may save any changes made to a script 80 or file 100 as part of the current version. In selected embodiments, a “save as version” button 112 may permit a developer to save changes to a script 80 or file 100 as part of a new version thereof. A “version selector” button 114 may permit a developer to select the version (e.g., version number) to be applied when the “save as version” button 112 is selected.

In selected embodiments, a developer may use a user interface 98 to specify and control which version of a particular script 80 or file 100 is to be published (e.g., made available to selected end users). In certain embodiments, a user interface 98 may include a “publish” button 116. Upon selecting the “publish” button 116, the version of a script 80 or file 100 displayed in the code editor 106 may become the published version. In selected embodiments, the version saved as version “0” may be the published version. Accordingly, publishing a script 80 or file 100 (e.g., selecting the “publish” button 116) may comprise saving it as version “0.” In selected embodiments, a user interface 98 may include a “delete” button 118. Selection of such a button 118 may permit a developer to delete the particular script 80 or file 100 displayed in the code editor 106.

In addition to supporting a developer in editing code 108, a user interface 98 as described hereinabove may grant to the developer the ability to test selected versions of scripts 80 or files 100. A system 10 in accordance with the present invention may directly source any of the individual versions of a script 80 that is available on a server 60b. Using a user interface 98, a developer may carve off a small portion of the total pool of end users. This small portion may be given a special menu or a beta group of tools (e.g., scripts 80). Accordingly, test versions may be evaluated, while the remaining portion of end users continue using published versions of the scripts 80.

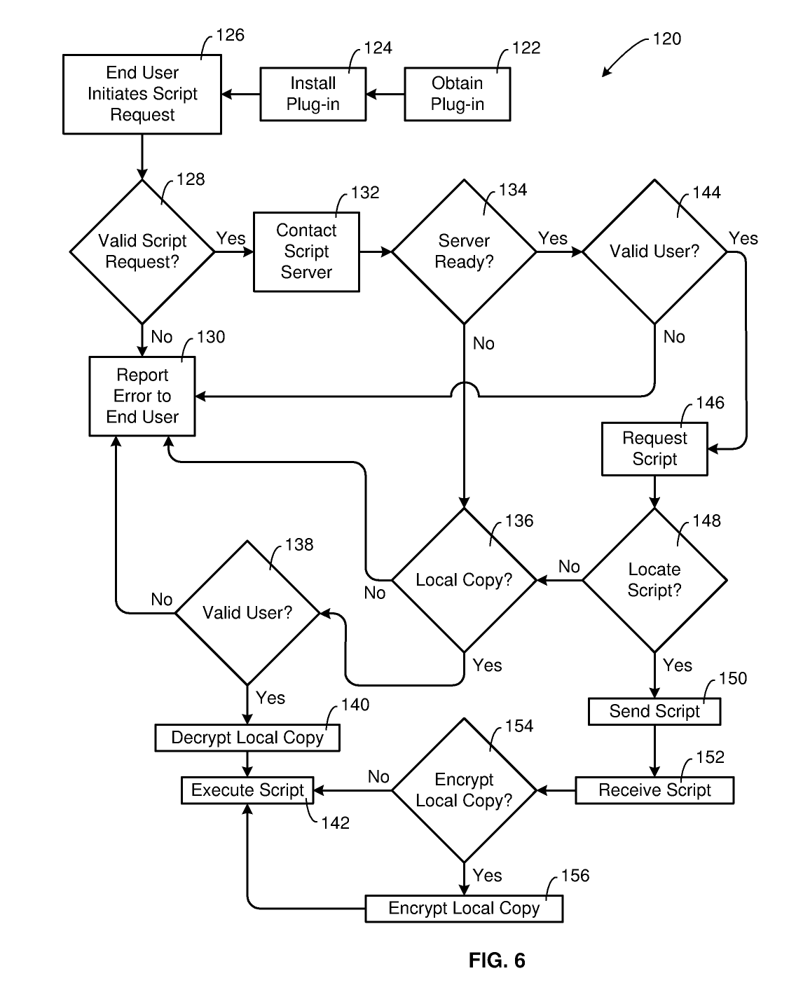

Referring to FIG. 6, in selected embodiments, a method 120 in accordance with the present invention may begin when an end user obtains 122 a copy of a plug-in 64 and installs 124 the plug-in 64 on the computer 12 of the end user. The end user may then initiate 126 a script request 68. This may be accomplished in any suitable manner. For example, an end user may select an item or a button. Such an item or button may be included or presented as part of the user interface of an application 62, as augmented by a plug-in 64. Alternatively, an end user may enter (e.g., type in) a command.

Once a script request 68 has been initiated 126, a system 10 in accordance with the present invention may determine 128 whether the script request 68 is valid. This determination may be based on simple formalities (e.g., communication protocols), the merits of the request 68, or some combination thereof. If the script request 68 is not valid, an error may be reported 130 to the end user. Alternatively, if the script request 68 is valid, a plug-in 64 may contact 132 a script server 60b.

A determination 134 may then be made as to whether a script server 60b is available and ready. In selected embodiments, a system 10 may include more than one script server 60b. For example, a system 10 may comprise a primary script server 60b and a backup script server 60b. Accordingly, in the event that a primary server 60b is unavailable, communications may be directed to a backup server 60b.

In the event that no script server 60b is available and ready, a determination 136 may be made as to whether the one or more scripts 80 identified in the script request 68 are stored locally (e.g., as encrypted copies 82) on the computer 12 of the end user. If the one or more scripts 80 are not stored locally, an error may be reported 130 to the end user. On the other hand, if the one or more scripts 80 are stored locally, an inquiry 138 may be made as to whether the end user associated with the script request 68 is a valid user. If the end user is not valid, an error may be reported 130 to the end user. Alternatively, if the end user is authorized to use the one or more scripts 80, the local encrypted copies 82 of the one or more scripts 80 may be decrypted 140 and executed 142.

In the event that a script server 60b is available and ready, a determination 144 may be made as to whether the end user associated with the script request 68 is a valid user. If the end user is not valid, an error may be reported 130 to the end user. Alternatively, if the end user is authorized to use the one or more scripts 80, the one or more scripts 80 may be requested 146.

A determination 148 may then be made as to whether the one or more scripts 80 have been located. If they have not been located, a system 10 may determine 136 whether the one or more scripts 80 identified in the script request 68 are stored locally (e.g., as encrypted copies 82) on the computer 12 of the end user. The method 120 may then continue as described hereinabove. Alternatively, if the one or more scripts 80 are located on the script server 60b, they may be sent 150 to the computer 12 of the end user.

Upon receipt 152 of the one or more scripts 80, a system 10 may determine 154 whether an end user desires to generate local, encrypted copies 80 of the one or more scripts 80. In selected embodiments, a preset value or command selected by an end user may provide the answer to this inquiry 154. Alternatively, an end user may be prompted to answer the inquiry 154 each time it arises.

If a user does not want to generate local, encrypted copies 80 of the one or more scripts 80 requested, the system 10 may move on and execute 142 the scripts 80 as described hereinabove. Alternatively, if a user desires to generate local, encrypted copies 80 of the one or more scripts 80 requested, a plug-in 64 may encrypt 156 local copies 82 of the scripts 80, then move on and execute 142 the scripts 80 as described hereinabove.

In a method 120 in accordance with the present invention, a system 10 may monitor end users and record when and from where the various end users access script servers 60b. With this information, a system 10 may be a tool for identifying and limiting unauthorized use of scripts 80. For example, an end user may contract (e.g., pay) for a one person license to a selected group of scripts 80. Accordingly, if that particular end user accesses a server 60b from London one hour, then from New York City the next hour, it is likely that the end user has breached that license.

That is, humans are not yet able to travel from London to New York City in one hour. Accordingly, it is likely that the license has been breached and more than one end user is accessing scripts 80 under that particular account. Action may therefore be taken to correct the breach. For example, the account may be canceled. Alternatively, the corresponding end user may be charged a fee corresponding to number of persons actually using the account.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A computer system comprising:
a first processor;
a first memory device operably connected to the first processor; and
the first memory device storing an application providing functionality and a plug-in augmenting the functionality, the plug-in comprising
a request module configured to generate a request for a script,
a communication module configured to contact a server and submit the request thereto,
an input module configured to receive the script from the server, and
an execution module configured to load the script directly into application memory corresponding to the application.

2. The computer system of claim 1, wherein the server comprises a second processor operably connected to a second memory device, the second processor and second memory device located remotely from the first processor and first memory device.

3. The computer system of claim 2, wherein the second memory device stores a plurality of scripts, the script being one of the plurality of scripts.

4. The computer system of claim 3, wherein the second memory device further stores a verification module configured to determine whether a user associated with the first processor is authorized to receive the script.

5. The computer system of claim 4, wherein the second memory device further stores a locator module configured to locate the script from within the plurality of scripts.

6. The computer system of claim 5, wherein the second memory device further stores an output module configured to send the script to the first processor.

7. The computer system of claim 6, wherein the input module is further configured to generate an encrypted copy of the script.

8. The computer system of claim 7, wherein the input module is further configured to save the encrypted copy within the first memory device.

9. The computer system of claim 1, wherein the input module is further configured to generate an encrypted copy of the script.

10. The computer system of claim 9, wherein the script input module is further configured to save the encrypted copy within the first memory device.

11. A computer system comprising:
a computer corresponding to an end user;
a server located remotely from the computer;
the computer running an application providing functionality and a plug-in augmenting the functionality, the plug-in comprising
a request module configured to generate a request for a script,
a communication module configured to contact the server and submit the request thereto,
an input module configured to receive the script from the server, and
an execution module configured to load the script directly into application memory corresponding to the application; and
the server connecting via a computer network to the computer and running software comprising
a verification module configured to determine whether the end user is authorized to receive the script, and
an output module configured to send the script to the script input module.

12. The computer system of claim 11, wherein the input module is further configured to generate an encrypted copy of the script.

13. The computer system of claim 12, wherein the input module is further configured to save the encrypted copy within the computer.

14. A method for serving a script over a computer network, the method comprising:
launching an application, augmented by a plug-in, on a computer of an end user;
generating, by the plug-in, a request for a script;
receiving, by a script server, the request;
determining, by the script server, that the end user is authorized to receive the script;
sending, by the script server, the script to the computer;
loading, by the plug-in, the script directly into application memory corresponding to the application; and
executing, by the computer, the script.

15. The method of claim 14, further comprising encrypting, by the plug-in, a copy of the script.

16. The method of claim 15, further comprising storing, by the plug-in, the copy as a local copy on the computer.

17. The method of claim 16, wherein generating further comprises selecting, by the end user, functionality offered by the plug-in.

18. The method of claim 14, wherein generating further comprises selecting, by the end user, functionality offered by the plug-in.
